(19) United States
(12) Patent Application Publication
(10) Pub. No.: US 2026/0285193 A1
(43) Pub. Date: Sep. 24, 2026

(54) SYSTEMS AND METHODS FOR RANGE ESTIMATION FOR TOWING VEHICLES TOWING SELF-PROPELLED TRAILERS

(71) Applicants: Hyundai Motor Company, Seoul (KR); Kia Corporation, Seoul (KR)

(72) Inventors: Shengrong Zhu, Superior Township, MI (US); Kyoung Pyo Ha, Superior Township, MI (US); Eric Kurtz, Superior Township, MI (US); Mark Shirley, Superior Township, MI (US); Da Chang, Superior Township, MI (US)

(21) Appl. No.: 19/085,059

(22) Filed: Mar. 20, 2025

(51) Int. Cl. B60L 58/12; B60L 58/16; G01C 21/34

(52) U.S. Cl. CPC B60L 58/12; B60L 58/16; G01C 21/3469; B60L 2200/28; B60L 2240/26; B60L 2240/545; B60L 2250/12; B60L 2250/16; B60L 2260/52

(57) ABSTRACT

Systems and methods for estimating a driving range of a tow vehicle towing a self-propelled trailer are provided. The method may comprise selecting, using a graphical user interface of a computing device, a towing configuration. The towing configuration may comprise a tow vehicle and a self-propelled trailer. The method may comprise calculating an energy consumption rate for driving for the tow vehicle and the self-propelled trailer and, for each of the tow vehicle and the self-propelled trailer, calculating a total remaining energy available for driving and calculating an estimated driving range, according to the energy consumption rate for driving and the total remaining energy available for driving.

### BACKGROUND

### Technical Field

Embodiments of the present disclosure relate to systems and methods for performing range estimation for towing vehicles towing self-propelled trailers.

### Background

The driving range of an electric vehicle (EV) is significantly reduced when the EV is towing a trailer and/or other towable device. For example, depending on the EV and the type of towable device being towed, the driving range may be reduced by 50% or more while towing.

Pickup truck buyers in the United States need to be able to tow trailers with utility and range. Since there are still a limited number of charging stations/infrastructures in the United States for tow travelers, increasing the effective range of EVs towing trailers is needed.

There are some trailers that have their own propulsion systems. A self-propelled trailer or e-trailer (electrified trailer) is a trailer has its own energy source (e.g., an internal combustion engine, battery, fuel cell, solar power, or some combination) and drivetrain that can propel the trailer with a small or even zero towing force required.

To tow an e-trailer, the towing vehicle typically still needs to pull the e-trailer with a force (e.g., for maneuverability), but a limited force (i.e., a predefined max allowable towing force) to minimize the towing impact on the towing vehicle driving range. However, this towing force affects the energy consumption rate for the tow vehicle and also the e-trailer and thus affects their driving ranges.

To coordinate the towing vehicle and the towed trailer, it is necessary to have an accurate estimate for the driving range of the e-trailer and its towing vehicle, so the vehicle control unit can react proactively for maximizing the overall travel distance. For end users, having the information on the driving range of the towing vehicle and the e-trailer will be very useful for planning purposes such as, e.g., for use in scheduling and selecting charging stations.

### SUMMARY

According to an object of the present disclosure, a method for estimating a driving range of a tow vehicle towing a self-propelled trailer is provided. The method may comprise selecting, using a graphical user interface of a computing device, a towing configuration. The towing configuration may comprise a tow vehicle and a self-propelled trailer. The method may comprise calculating an energy consumption rate for driving for the tow vehicle and the self-propelled trailer and, for each of the tow vehicle and the self-propelled trailer, calculating a total remaining energy available for driving and calculating an estimated driving range, according to the energy consumption rate for driving and the total remaining energy available for driving.

According to an exemplary embodiment, the selecting the towing configuration may comprise selecting a towing configuration from a plurality of pre-defined towing configurations.

According to an exemplary embodiment, the calculating the energy consumption rate for driving may comprise determining a towing force and a tongue force.

According to an exemplary embodiment, the calculating the energy consumption rate for driving may comprise determining a mass and resistance coefficients based on the selected towing configuration.

According to an exemplary embodiment, the calculating the energy consumption rate for driving may comprise configuring a travel route of the tow vehicle.

According to an exemplary embodiment, for each of the tow vehicle and the self-propelled trailer, the calculating the total remaining energy available for driving may comprise detecting, using one or more sensors, one or more of: a battery state of charge; a battery state of health; and a battery state of temperature.

According to an exemplary embodiment, for each of the tow vehicle and the self-propelled trailer, the calculating the total remaining energy available for driving may comprise estimating an energy needed for conditioning.

According to an exemplary embodiment, for each of the tow vehicle and the self-propelled trailer, the calculating the total remaining energy available for driving may comprise subtracting battery stored energy by the energy needed for conditioning.

According to an exemplary embodiment, the tow vehicle may comprise an electric vehicle comprising a battery.

According to an exemplary embodiment, the electric vehicle may comprise a pickup truck.

According to an exemplary embodiment, the method may comprise, when the tow vehicle is in motion, continuously updating the estimated drive range.

According to an object of the present disclosure, a system for estimating a driving range of a tow vehicle towing a self-propelled trailer is provided. The system may comprise the self-propelled trailer and the tow vehicle. The tow vehicle may comprise a computing device. The computing device may comprise a processor and a memory. The memory may be configured to store instructions that, when executed by the processor, are configured to cause the processor to select, using a graphical user interface of the computing device, a towing configuration. The towing configuration may comprise a tow vehicle and a self-propelled trailer. The instructions, when executed by the processor, may be configured to cause the processor to calculate an energy consumption rate for driving for the tow vehicle and the self-propelled trailer, and, for each of the tow vehicle and the self-propelled trailer, calculate a total remaining energy available for driving and calculate an estimated driving range, according to the energy consumption rate for driving and the total remaining energy available for driving.

According to an exemplary embodiment, the selecting the towing configuration may comprise selecting a towing configuration from a plurality of pre-defined towing configurations.

According to an exemplary embodiment, the calculating the energy consumption rate for driving may comprise determining a towing force and a tongue force.

According to an exemplary embodiment, the calculating the energy consumption rate for driving may comprise determining a mass and resistance coefficients based on the selected towing configuration.

According to an exemplary embodiment, the calculating the energy consumption rate for driving may comprise configuring a travel route of the tow vehicle.

According to an exemplary embodiment, for each of the tow vehicle and the self-propelled trailer, the calculating the total remaining energy available for driving may comprise detecting, using one or more sensors, one or more of: a battery state of charge; a battery state of health; and a battery state of temperature.

According to an exemplary embodiment, for each of the tow vehicle and the self-propelled trailer, the calculating the total remaining energy available for driving may comprise estimating an energy needed for conditioning.

According to an exemplary embodiment, for each of the tow vehicle and the self-propelled trailer, the calculating the total remaining energy available for driving may comprise subtracting battery stored energy by the energy needed for conditioning.

According to an exemplary embodiment, the tow vehicle may comprise an electric vehicle comprising a battery.

According to an exemplary embodiment, the electric vehicle may comprise a pickup truck.

According to an exemplary embodiment, the instructions, when executed by the processor, may be configured to cause the processor to continuously update the estimated drive range when the tow vehicle is in motion.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1A illustrates an electric tow vehicle towing an electricity-powered trailer (e-trailer), according to an exemplary embodiment of the present disclosure.

FIG. 1B illustrates a hybrid electric vehicle (HEV) tow vehicle towing an e-trailer, according to an exemplary embodiment of the present disclosure.

FIG. 1C illustrates an internal combustion engine (ICE)-powered tow vehicle towing an e-trailer, according to an exemplary embodiment of the present disclosure.

FIG. 2 illustrates electric tow vehicles towing e-trailers, according to an exemplary embodiment of the present disclosure.

FIGS. 3A-3C illustrate an electric tow vehicle towing an e-trailer along an inclined plane, according to an exemplary embodiment of the present disclosure.

FIG. 4 illustrates a flowchart of a process for estimating a driving range (DR) of a tow vehicle towing an e-trailer, according to an exemplary embodiment of the present disclosure.

FIG. 5 illustrates a method for estimating a DR for a tow vehicle towing an e-trailer, according to an exemplary embodiment of the present disclosure.

FIG. 6 illustrates a plurality of towing configurations, according to an exemplary embodiment of the present disclosure.

FIG. 7 illustrates a flowchart of a process for estimating a DR of a tow vehicle towing an e-trailer, according to an exemplary embodiment of the present disclosure.

FIG. 8 illustrates an example architecture of a vehicle, according to an exemplary embodiment of the present disclosure.

FIG. 9 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for systems and methods for performing range estimation for towing vehicles (e.g., electric towing vehicles) towing self-propelled trailers (aka e-trailers) are provided.

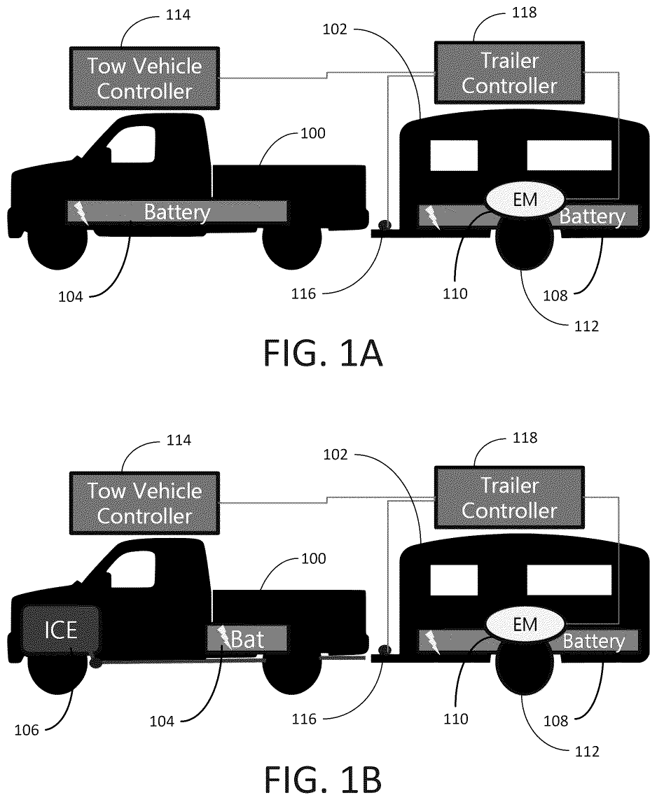

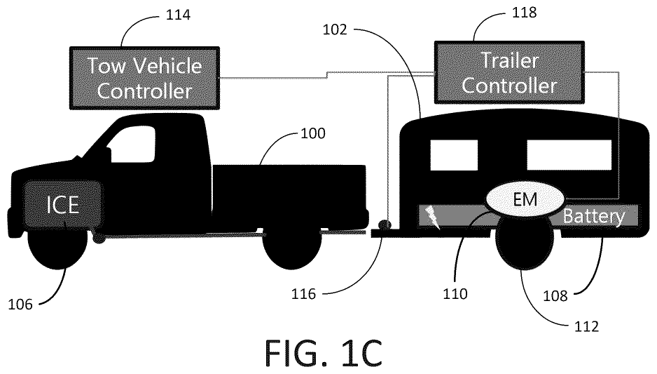

Referring now to FIGS. 1A-1C, tow vehicles 100 towing e-trailers 102 are illustratively depicted, in accordance with exemplary embodiments of the present disclosure. According to an exemplary embodiment, the tow vehicle 100 and the e-trailer 102 may form a system for coordinating the propulsion of the e-trailer 102.

The tow vehicle 100 may comprise an electric vehicle (EV) (as shown in FIG. 1A) comprising a battery 104, a hybrid EV (HEV) (as shown in FIG. 1B) comprising a battery 104 and an internal combustion engine (ICE) 106, or an ICE-powered vehicle (as shown in FIG. 1C) comprising an ICE 106. It is noted, however, that other suitable tow vehicles 100 may be incorporated while maintaining the spirit and functionality of the present disclosure. According to an exemplary embodiment, the ICE 106 may be configured to run on gasoline, diesel, and/or other suitable fuel.

According to an exemplary embodiment, the e-trailer 102 may comprise a battery 108. According to an exemplary embodiment, the size of the battery 108 in the e-trailer 102 may be equal to or less than the size of the battery 104 on the tow vehicle 100 (e.g., the battery 104 in the EV of FIG. 1A and HEV of FIG. 1B). This may prevent different charge times for the batteries 104 and 108 since the battery 104 of the tow vehicle 100 would be greater than or equal to the battery 108 of the e-trailer 102.

According to an exemplary embodiment, the e-trailer 102 may comprise at least one motor 110. The at least one motor 110 may be configured to propel the e-trailer 102. The e-trailer 102 may comprise one or more wheels 112 and the at least one motor 110 may be configured to drive the one or more wheels 112.

According to an exemplary embodiment, the e-trailer 102 may comprise a trailer controller 118. The trailer controller 118 may comprise a computing device. The computing device may comprise one or more processors, memory, graphical user interfaces, power sources, and/or other suitable components. According to an exemplary embodiment, the trailer controller 118 may be configured to control one or more functions of the e-trailer 102.

According to an exemplary embodiment, a sensor 116 may be positioned between the e-trailer 102 and the tow vehicle 100. The sensor 116 may be configured to determine a force (Fr) exerted from the tow vehicle 100 to the e-trailer 102 or vice versa. According to an exemplary embodiment, the sensor 116 may be coupled to the trailer controller 118 via wired and/or wireless connection.

According to an exemplary embodiment, the tow vehicle 100 may comprise a tow vehicle controller 114. The tow vehicle controller 114 may comprise a computing device. The computing device may comprise one or more processors, memory, graphical user interfaces, power sources, and/or other suitable components. According to an exemplary embodiment, the tow vehicle controller 114 may be configured to control one or more functions of the tow vehicle 100. According to an exemplary embodiment, the sensor 116 may be coupled to the tow vehicle controller 114 via wired and/or wireless connection.

According to an exemplary embodiment, the sensor 116 may be configured to sense, record, and/or send, from the tow vehicle controller 114 to the trailer controller 118 one or more data points. The one or more data points may describe and/or be indicative of a tow vehicle 100 type (e.g., EV, HEV, ICE, etc.), a tow vehicle 100 state of charge (SOC) (e.g., for an EV or HEV), an estimated tow vehicle 100 electric range (e.g., for an EV or HEV), an exhaust temperature (e.g., for ICE or HEV), an engine speed and load (e.g., for ICE or HEV), a water temperature (e.g., for an ICE or HEV), an oil temperature (e.g., for an ICE or HEV), a fuel temperature (e.g., for an ICE or HEV), an engine operating mode (e.g., for an ICE or HEV), a tow vehicle 100 total drag estimate, an e-trailer 102 total drag estimate, a tow vehicle 100 weight estimate, an e-trailer 102 weight estimate, and/or other suitable data points. According to an exemplary embodiment, one or more of the data points (e.g., the tow vehicle type 100) may be configured to be input by a user.

According to an exemplary embodiment, the trailer controller 118 and/or the tow vehicle controller 114 may be configured to determine an amount of power and/or torque to provide by the e-trailer motor 110. This amount of power may be determined via programmed control logic.

According to an exemplary embodiment, the goal of the control logic may depend on the tow vehicle 100 type (e.g., EV, gasoline ICE, diesel ICE, HEV, etc.). According to an exemplary embodiment, for an EV tow vehicle 100, the control logic may be responsive to one or more of the following: the available SOC of the battery 108 of the e-trailer 102, the e-trailer's 102 estimated weight and drag, the available SOC of the battery 104 of the tow vehicle 100, and the tow vehicle's estimated weight and drag. According to an exemplary embodiment, for a gasoline ICE tow vehicle 100, the control logic may be responsive to one or more of the following: the available SOC of the battery 108 of the e-trailer 102, an exhaust temperature, an engine speed and load, and a coolant, oil, and/or fuel temperature. According to an exemplary embodiment, for a diesel ICE tow vehicle 100, the control logic may be responsive to one or more of the following: the available SOC of the battery 108 of the e-trailer 102, an engine operating mode (e.g., catalyst light-off, normal, regen, etc.), an exhaust temperature, an engine speed and load, and a coolant, oil, and/or fuel temperature.

According to an exemplary embodiment, the source of the available SOC of the battery 108 of the e-trailer 102 may be from an e-trailer 102 battery management system (BMS) and/or other suitable source. According to an exemplary embodiment, the BMS value may be reduced by a customer/user via an app, from an electronic control unit (ECU) of the e-trailer 102, and/or other suitable means, accounting for a desired SOC upon arrival.

According to an exemplary embodiment, the source of the e-trailer 102 estimated weight may be an estimation/calculation, a customer/user input (e.g., via an app), a measurement of the sensor 116, and/or via other suitable source.

According to an exemplary embodiment, the source of the e-trailer 102 estimated drag may be an estimation/calculation, a lookup table (ECU or cloud) based on customer/user input (e.g., via an app identifying the tow vehicle's 100 make and model and the e-trailer 102 model), a measurement of the sensor 116, and/or via other suitable source.

According to an exemplary embodiment, the source of the available SOC of the battery 104 of the tow vehicle 100 may be the e-trailer 102 BMS and/or other suitable source. According to an exemplary embodiment, the BMS value needed for climate control may be reduced based on, e.g., current vehicle settings and/or a weather app.

According to an exemplary embodiment, the source of the tow vehicle's 100 estimated weight may be an estimation/calculation, a customer/user input (e.g., via an app), a lookup table (ECU or cloud) based on customer/user input (e.g., via an app identifying the tow vehicle's 100 make and model), via a percentage of the e-trailer's 100 weight (e.g., based on communication from the e-trailer's 102 ECU) to account for tongue weight, and/or other suitable source.

According to an exemplary embodiment, the source of the tow vehicle's 100 estimated drag may be an estimation/calculation, a lookup table (ECU or cloud) based on customer/user input (e.g., via an app identifying the tow vehicle's 100 make and model and the e-trailer's 102 model), and/or other suitable source.

According to an exemplary embodiment, the source of gasoline and/or diesel ICE parameters may be from ECU (e.g., via physical connection or wireless connection) and/or other suitable source.

According to an exemplary embodiment, the source of the tow vehicle's 100 rear height may be a measurement of the sensor 116 (e.g., a ride height sensor) and/or other suitable source.

According to an exemplary embodiment, the source of the e-trailer 102 hitch force may be a measurement of the sensor 116 (e.g., a force sensor or strain gage located between the tow vehicle 100 and the e-trailer 102) and/or other suitable source.

It may first be imperative to recognize what type of vehicle is being used as the tow vehicle 100. This may be accomplished using any number of methods. According to an exemplary embodiment, determining the type of vehicle being used as the tow vehicle 100 may comprise recognizing one or more signals from the tow vehicle 100. For example, there may be a flag in the powertrain control module (PCM) of the tow vehicle 100 indicating the vehicle type. This signal may be received in the e-trailer 102. According to an exemplary embodiment, signals from the tow vehicle 100 may be received in the e-trailer 102 and the type of vehicle that is towing the e-trailer 102 may be inferred as follows: determining whether the tow vehicle 100 has an ICE; and determining whether the tow vehicle 100 uses electrified propulsion.

According to an exemplary embodiment, signals indicating an ICE engine is present may comprise signals indicating a fuel tank level, an engine rpm reading, a fuel injection quantity, a catalyst temperature, and/or other suitable signals.

According to an exemplary embodiment, signals indicating that an ICE engine is a diesel engine may comprise signals indicating a urea injection quantity, a flag for a diesel particulate filter (DPF) filter regen, and/or other suitable signals. According to an exemplary embodiment, signals indicating that the ICE engine is not a diesel engine may comprise signals indicating a spark timing, which should not exist for a diesel engine, and/or other suitable signals.

According to an exemplary embodiment, signals indicating that the tow vehicle 100 has electrified propulsion may comprise signals indicating a motor rpm, a battery voltage being above a threshold, a motor temperature, a current, and/or other suitable signals.

According to an exemplary embodiment, when electrified propulsion signals are present and ICE signals are not present, it may be determined that the tow vehicle 100 is an EV. According to an exemplary embodiment, when electrified propulsion signals are present and ICE signals are also present, it may be determined that the tow vehicle 100 is an HEV. According to an exemplary embodiment, when electrified propulsion signals are not present and ICE signals are present, it may be determined that the tow vehicle 100 is an ICE-powered vehicle.

According to an exemplary embodiment, when the driving ranges for the tow vehicle 100 and the e-trailer 102 are unknown to the tow vehicle controller 114, the towing system (e.g., one or more of the components shown and described in FIGS. 1A-1C, including the tow vehicle 100 and the e-trailer 102) may be configured to react passively, and the overall range of the towing system may depend on the energy available in both sub-systems (the tow vehicle 100 and the e-trailer 102). According to an exemplary embodiment, when the tow system reacts passively, the towing force between the tow vehicle 100 and the e-trailer 102 is maintained at a default/constant value.

According to an exemplary embodiment, when the driving ranges for the tow vehicle 100 and the e-trailer 102 are known to the tow vehicle controller 114, then the towing system may react proactively and the overall range may be improved when the tow vehicle 100 range is less than that of the e-trailer 102. According to an exemplary embodiment, when the tow system reacts proactively, the towing force between the tow vehicle 100 and the e-trailer 102 may vary accordingly per a control request.

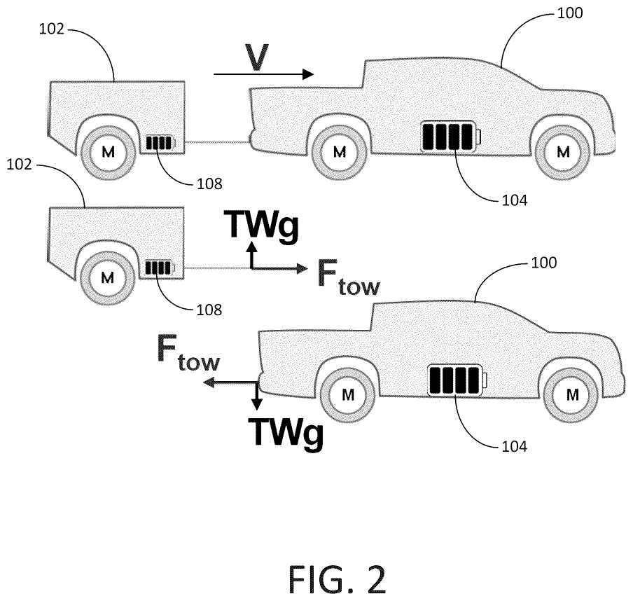

The sensor 116 may be configured to monitor a towing force, F_{tow}, and/or tongue force, TWg, between the tow vehicle 100 and the e-trailer 102. As shown in FIG. 2, V is the tow vehicle 100 speed, TW is the tongue weight, g is the acceleration due to gravity, and F_{tow} is the towing force. According to an exemplary embodiment, the trailer controller 118 may be configured to use the monitored F_{tow} to control the drive in such a way that F_{tow} will not exceed a predefined value (the maximum F_{tow} allowable) when the power source of e-trailer 102 can power and drive the e-trailer 102. F_{tow} typically has a small value, e.g., 500-1000N, to minimize its impact on the driving range of the tow vehicle 100. It is noted, however, that the F_{tow} may incorporate other suitable values, while maintaining the spirit and functionality of the present disclosure.

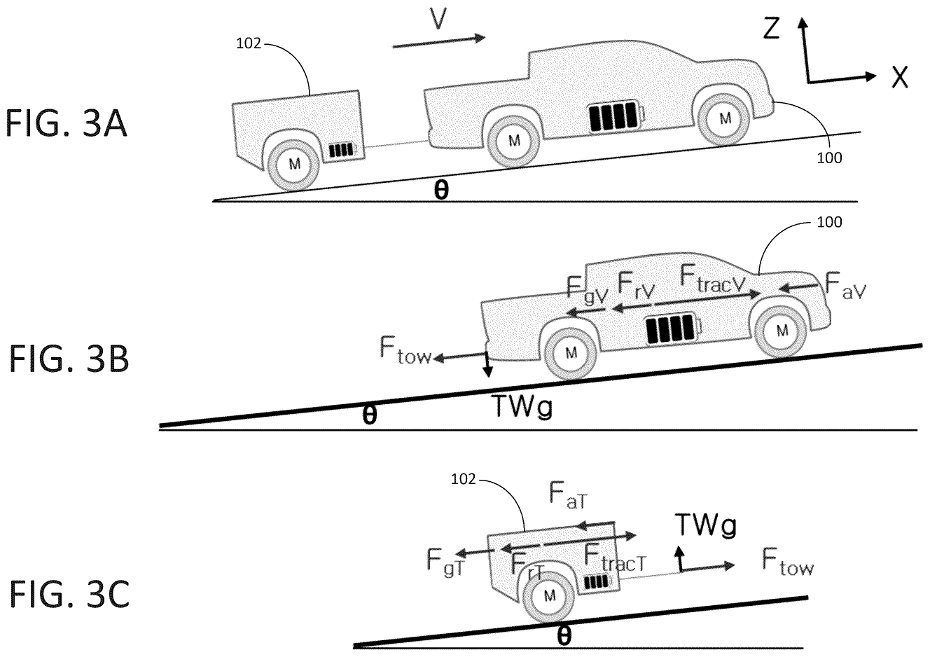

As shown, e.g., in FIGS. 3A-3C, when the tow vehicle 100 and e-trailer 102 are traveling at speed, V, on a road with grade, θ, as shown in FIG. 3A, a longitudinal vehicle dynamic model for both the tow vehicle 100 and the e-trailer 102 are shown in FIGS. 3B-3C.

According to an exemplary embodiment, the traction force of the towing vehicle, F_{tracV}, and the traction force of the e-trailer, F_{tracT}, may be determined from an actual powertrain output and known drivetrain efficiency. The mass of the towing vehicle, My, and the mass of the e-trailer, M_{T}, may be sensed directly with load sensors (e.g., sensor 116), e.g., mounted on the suspension system, or estimated per Equation 1 and Equation 2.

$$\begin{matrix}{F}_{tracV} - {F}_{tow} = {M}_{v} a + {F}_{aV} + {F}_{rV} + {F}_{gV} \\ = {M}_{v} ( dV / dt ) + 0.5 ρ {C}_{dV} {A}_{V} {V}^{2} + \\ ( {M}_{v} g cos ( θ ) + TWg ) {C}_{rV} + \\ {M}_{v} g sin ( θ )\end{matrix} \qquad Equation 1$$

$$\begin{matrix}{F}_{tracV} + {F}_{tow} = {M}_{T} a + {F}_{aT} + {F}_{rT} + {F}_{gT} \\ = {M}_{T} ( dV / dt ) + 0.5 ρ {C}_{dT} {A}_{T} {V}^{2} + \\ ( {M}_{T} g cos ( θ ) - TWg ) {C}_{rT} + \\ {M}_{T} g sin ( θ )\end{matrix} \qquad Equation 2$$

The longitudinal acceleration of the tow vehicle 100 and the e-trailer 102, a=(dV/dt), may be calculated from the speedometer. F_{aV} and F_{aT} are the aerodynamic drag of the tow vehicle 100 and the e-trailer 102, Fry and Fer are the rolling resistance of the tow vehicle 100 and the e-trailer 102, F_{gV} and F_{gT} are the downgrade force of the tow vehicle 100 and the e-trailer 102, C_{rV} and C_{rT} are the rolling resistance coefficient of the tow vehicle 100 and the e-trailer 102 (may be obtained, e.g., from manufacturers and/or stored in the tow vehicle controller 114, the trailer controller 118, etc., and/or through other suitable means), C_{dV} and C_{dT}, are the aerodynamic drag coefficient of the tow vehicle 100 and the e-trailer 102 (depending on the specific tow vehicle 100 and e-trailer 102 configuration, C_{dV} and C_{dT} may be calculated from Equation 1 and Equation 2), ρ is the air density (may be obtained from ambient condition sensing and/or other suitable means), A_{V} and A_{T} are the projected front area of the tow vehicle 100 and the e-trailer 102 (may be obtained from manufacturers for the nominal values and/or through other suitable means), and θ is the road grade (may be obtained through a stored map, GPS data, etc., and/or estimated from Equation 1 and Equation 2).

When the sensed towing force, F_{tow}, and the tongue force, TWg, are known, then there are three unknown parameters for each equation: elements M_{V}, C_{dV}, and θ are unknown in Equation 1; and elements M_{T}, C_{dT}, and θ are unknown in Equation 2. To determine these unknown parameters, a user may use a data set with three different vehicle speeds at minimum, or, with a vehicle accelerometer measuring acceleration, a, then θ may be obtained by Equation 3, since a longitudinal accelerometer may measure a sum of gravitational acceleration and longitudinal acceleration. Then a user may use a data set with two different vehicle speeds at minimum to determine the remaining unknown parameters.

$$θ = {sin}^{- 1} ( \frac{a - \frac{{dV}_{whl}}{dt}}{g} ) \qquad Equation 3$$

In Equation 3, V_{whl} is the wheel speed.

According to an exemplary embodiment, when θ is obtained through a stored map or GPS data, then similarly, a user may use a data set with two different vehicle speeds at minimum to determine the remaining unknown parameters.

According to an exemplary embodiment, after the unknown parameters in Equation 1 and Equation 2 are determined, then, for a given driving profile (e.g., speed vs time), the destination route map and the traction forces, F_{tracT} and F_{tracV}, may be determined and the traction power may be calculated, according to Equation 4, and, in turn, the energy consumption rate for driving (ECRD), in kWh/mile, may be estimated based on the powertrain/drivetrain or system efficiency maps, for the e-trailer 102 and the tow vehicle 100, respectively.

$${P}_{trac} = {F}_{trac} V \qquad Equation 4$$

The energy source state (i.e., states of charge/temperature/health, etc.) for the e-trailer 102 and the tow vehicle 100 may be obtained from each one's battery management system (BMS). Then, the effective remaining energy available for driving, Q_{d}, in kWh, may be determined by subtracting the energy needed for conditioning (non-traction uses; e.g., heating or cooling battery, cabin conditioning for towing vehicle, etc.) from the total available energy. Then, the driving range, DR, in miles, may be determined according to Equation 5, for the e-trailer 102 and, similarly, for the tow vehicle 100.

$$DR = \frac{{Q}_{d}}{ECRD} \qquad Equation 5$$

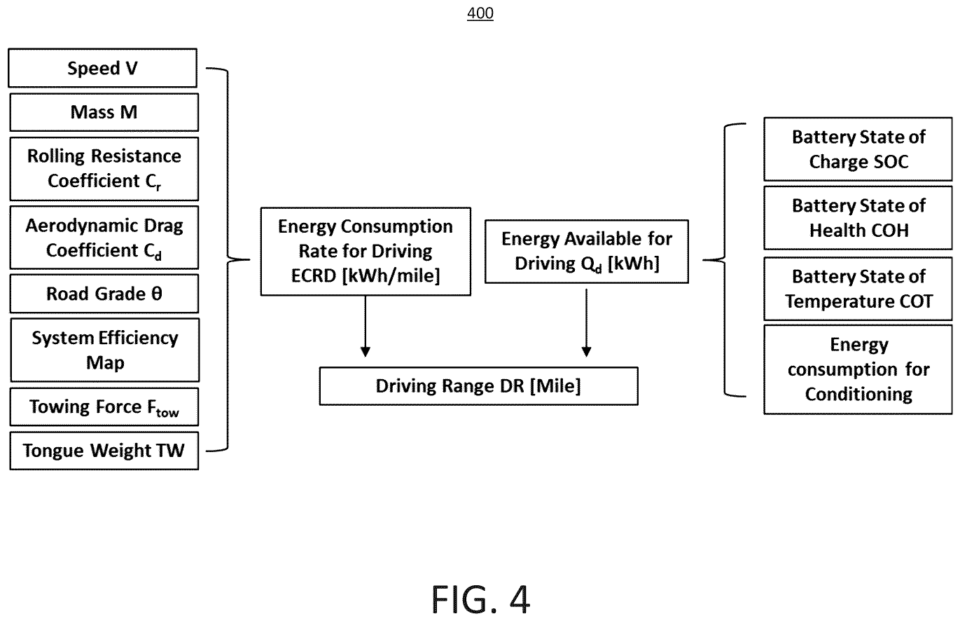

As shown in FIG. 4, a flowchart 400 of a process for estimating the DR is illustratively depicted, in accordance with an exemplary embodiment of the present disclosure.

As shown in FIG. 4, one or states of the tow vehicle 100 may be incorporated in determining the ECRD. These one or more states may comprise the tow vehicle's 100 speed, V, the mass, M, the rolling resistance coefficient, Cᵣ, the aerodynamic drag coefficient, C_{d}, the road grade, θ, the system efficiency map, the towing force, F_{tow}, the tongue weight, TW, and/or other suitable states.

As shown in FIG. 4, one or more energy source states may be incorporated in determining the energy available for driving, Q_{d}, for the e-trailer 100 and the tow vehicle 100. The one or more energy source states may comprise the battery state of charge (SOC), the battery state of health (SOH), the battery state of temperature (SOT), the energy consumption or conditioning, and/or other suitable energy source states.

As shown in Equation 5, the DR may be estimated using the ECRD and the Q_{d}. It is noted that the estimation method presented in FIG. 4 and Equation 5 works when the tow vehicle and the e-trailer are in motion.

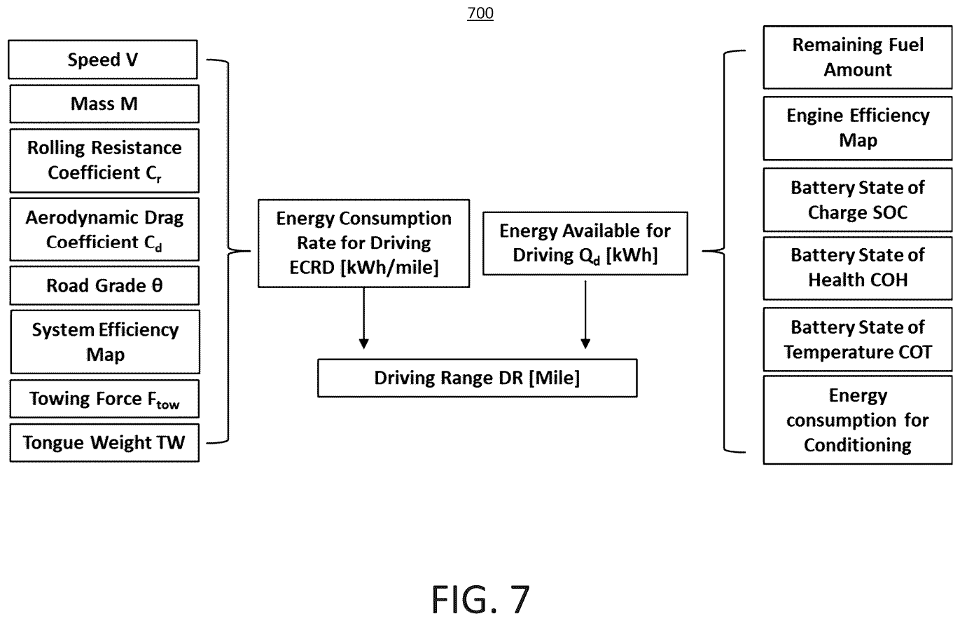

According to an exemplary embodiment, the e-trailer and/or tow vehicle power source may comprise an internal combustion engine (ICE) or a hybrid system with an ICE and a battery pack. The hybrid system may be a series hybrid (e.g., when the ICE functions as a generator only) or parallel hybrid (e.g., when the ICE can drive the tow vehicle and charge the battery). In either case, the effective energy for driving from ICE and the remaining fuel amount may be calculated based on the engine efficiency map. In this case, the flowchart 700 for driving range estimation is shown, e.g., in FIG. 7. According to an exemplary embodiment, when the tow vehicle or the e-trailer is an ICE-only system, the SOC equals zero.

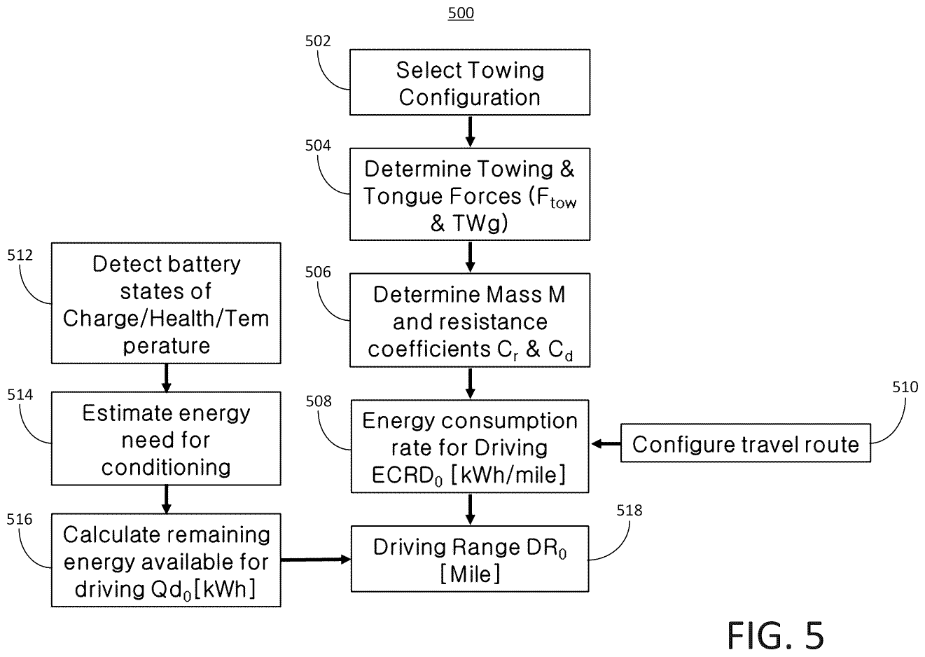

Referring now to FIG. 5, a method 500 for estimating a driving range (DR) for a tow vehicle 100 towing an e-trailer is illustratively depicted, in accordance with an exemplary embodiment of the present disclosure.

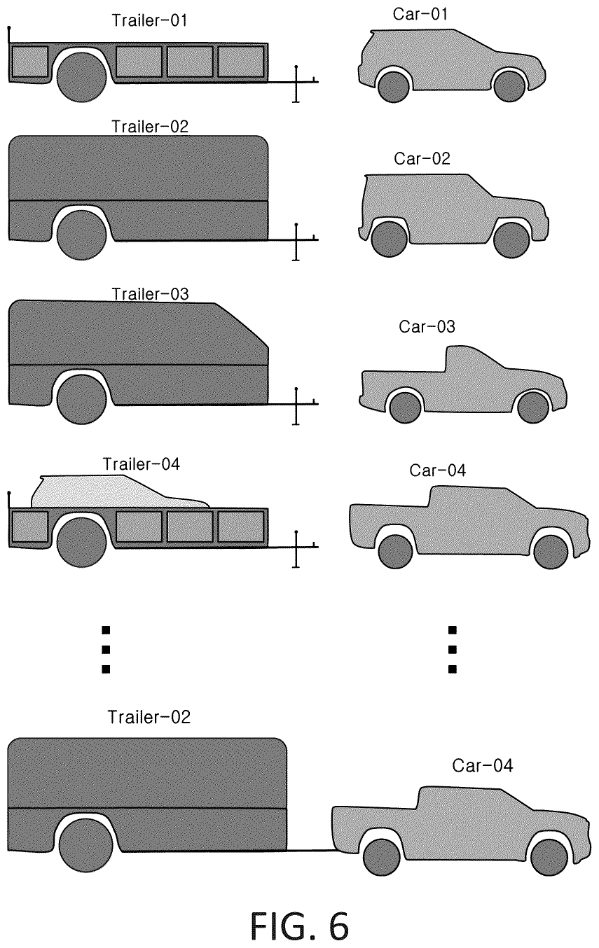

For end users of an e-trailer, it is helpful if the DR estimate is provided when the tow vehicle is in park and after the e-trailer is loaded, without any vehicle movement. For this need, the control unit for the e-trailer may be stored with some pre-defined towing configurations, so that end users may, at 502, select one of these pre-defined towing configurations, or use a default setting (e.g., assume a typical tow vehicle and e-trailer loading condition) to have a drive range estimate. The user may select the towing configuration using a graphical user interface of a computing device and/or other suitable means. According to an exemplary embodiment, some towing configurations correlating to typical towing scenarios may be pre-populated and provided to end users to select for a more accurate estimate. For example, as shown in FIG. 6, some towing configurations may comprise an SUV (Car-01) and an e-trailer (Trailer-01), an SUV (Car-02) and an e-trailer (Trailer-02), a pickup truck (Car-03) and an e-trailer (Trailer-03), a pickup truck (Car-04) and an e-trailer (Trailer-04), a default configuration (e.g., Car-04 and Trailer 02), and/or other suitable configurations. According to an exemplary embodiment, the default setting may be edited and saved per user preference. Using pre-defined towing scenarios provides a more accurate initial estimate on the driving range when the tow vehicle is in park.

At 504, the towing force, F_{tow}, and the tongue force, TWg, may be determined. According to an exemplary embodiment, to determine the towing force, F_{tow}, and the tongue force, TWg, a maximum F_{tow} may be used. According to an exemplary embodiment, the maximum F_{tow} may be predefined, tongue weight sensed, and/or estimated from the weight censored on the e-trailer axle, considering a typical tongue weight percent.

According to an exemplary embodiment, the tongue force, TWg, may be estimated instead of being sensed directly, e.g., using Equation 1 and Equation 2, or assuming the tongue weight, TW, is a certain percent of the trailer weight (e.g., 10-20%).

At 506, a mass, M, and resistance coefficients, Cᵣ and C_{d}, may be determined. According to an exemplary embodiment, the determining the mass, M, and the resistance coefficients, Cᵣ and C_{d}, may comprise using the selected towing configuration and stored Cᵣ and C_{d} lookup tables, determining the initial Cᵣ and C_{d}. According to an exemplary embodiment, the corresponding Ca values may be obtained through computational fluid dynamics (CFD) simulations, through a wind tunnel test, and/or through other suitable means. For the mass, M, for the tow vehicle and the e-trailer, each one may reference to some typical gross vehicle weight (e.g., maximum allowable gross vehicle weight, or some percentage of that as a typical value).

At 508, the ECRD may be determined, in accordance with the towing force, F_{tow}, the tongue force, TWg, the mass, M, and the resistance coefficients, Cᵣ and C_{d}. According to an exemplary embodiment, the ECRD may be determined in conjunction with a travel route. The travel route may be configured, at 510. According to an exemplary embodiment, when configuring the travel route, GPS data may be used, if available, or typical drive cycles, to determine a drive profile. Using the travel route, the ECRD may be determined, at 508.

At 512, using one or more sensors, the SOC, SOH, and SOT for the tow vehicle and/or the e-trailer may be detected. Using the SOC, SOH, and SOT, the energy needed for conditioning (non-traction uses; e.g., heating or cooling battery, cabin conditioning for towing vehicle, etc.) may be estimated, at 514.

At 516, the total remaining energy available for driving, Q_{d}, may be calculated. According to an exemplary embodiment, the total remaining energy available for driving, Q_{d}, may be calculated by subtracting the battery stored energy by the energy needed for conditioning.

At 518, the drive range (DR) for the tow vehicle and for the e-trailer may, respectively, be determined, according to Equation 5.

According to an exemplary embodiment, once the tow vehicle is in motion, the driving range estimate may be updated continuously, repeating one or more of steps 502-518.

According to an exemplary embodiment, the tow vehicle and the e-trailer may be considered as two separate systems while they are linked with the same towing force (F_{tow}) and tongue force (TWg).

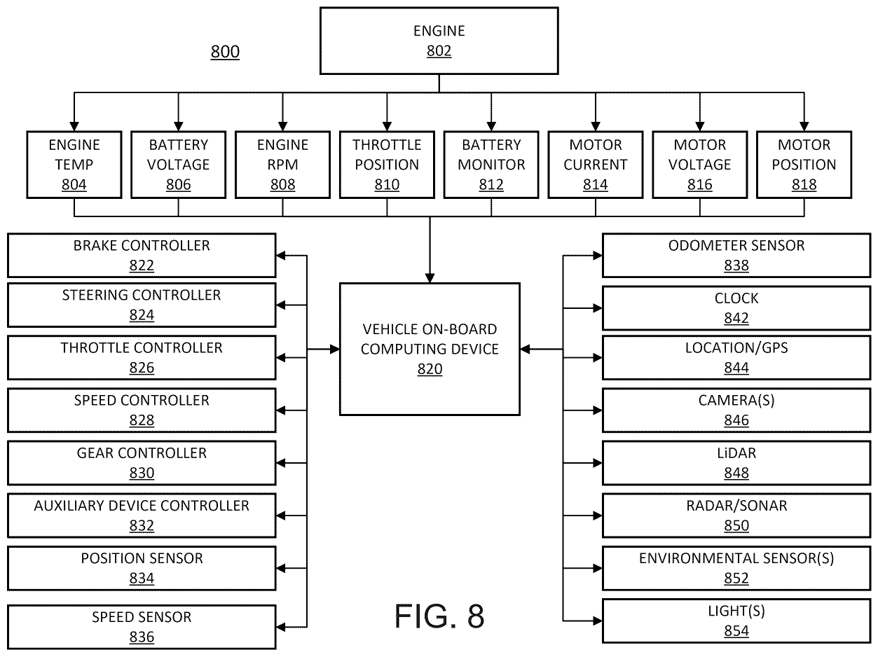

Referring now to FIG. 8, an example vehicle system architecture 800 for a vehicle is provided, in accordance with an exemplary embodiment of the present disclosure. The following discussion of vehicle system architecture 800 is sufficient for understanding one or more components of tow vehicle 100.

As shown in FIG. 8, the vehicle system architecture 800 may comprise an engine, motor or propulsive device 802 and various sensors 804-818 for measuring various parameters of the vehicle system architecture 800. In gas-powered or hybrid vehicles having a fuel-powered engine, the sensors 804-818 may comprise, for example, an engine temperature sensor 804, a battery voltage sensor 806, an engine Rotations Per Minute (RPM) sensor 808, and/or a throttle position sensor 810. If the vehicle is an electric or hybrid vehicle, then the vehicle may comprise an electric motor, and accordingly may comprise sensors such as a battery monitoring system 812 (to measure current, voltage and/or temperature of the battery), motor current 814 and voltage 816 sensors, and motor position sensors such as resolvers and encoders 818.

Operational parameter sensors that are common to both types of vehicles may comprise, for example: a position sensor 834 such as an accelerometer, gyroscope and/or inertial measurement unit; a speed sensor 836; and/or an odometer sensor 838. The vehicle system architecture 800 also may comprise a clock 842 that the system uses to determine vehicle time and/or date during operation. The clock 842 may be encoded into the vehicle on-board computing device 820, it may be a separate device, or multiple clocks may be available.

The vehicle system architecture 800 may comprise various sensors that operate to gather information about the environment in which the vehicle is traveling. These sensors may comprise, for example: a location sensor 844 (for example, a Global Positioning System (GPS) device); object detection sensors such as one or more cameras 846; a LIDAR sensor system 848; and/or a radar and/or a sonar system 850. The sensors may comprise environmental sensors 852 such as, e.g., a humidity sensor, a precipitation sensor, a light sensor, and/or ambient temperature sensor. The object detection sensors may be configured to enable the vehicle system architecture 800 to detect objects that are within a given distance range of the vehicle in any direction, while the environmental sensors 852 may be configured to collect data about environmental conditions within the vehicle's area of travel. According to an exemplary embodiment, the vehicle system architecture 700 may comprise one or more lights 854 (e.g., headlights, flood lights, flashlights, etc.).

During operations, information may be communicated from the sensors to an on-board computing device 820 (e.g., tow vehicle controller 114, trailer controller 118, and computing device 900). The on-board computing device 820 may be configured to analyze the data captured by the sensors and/or data received from data providers and may be configured to optionally control operations of the vehicle system architecture 800 based on results of the analysis. For example, the on-board computing device 820 may be configured to control: braking via a brake controller 822; direction via a steering controller 824; speed and acceleration via a throttle controller 826 (in a gas-powered vehicle) or a motor speed controller 828 (such as a current level controller in an electric vehicle); a differential gear controller 830 (in vehicles with transmissions); and/or other controllers. The brake controller 822 may comprise a pedal effort sensor, pedal effort sensor, and/or simulator temperature sensor, as described herein.

Geographic location information may be communicated from the location sensor 844 to the on-board computing device 820, which may then access a map of the environment that corresponds to the location information to determine known fixed features of the environment such as streets, buildings, stop signs and/or stop/go signals. Captured images from the cameras 846 and/or object detection information captured from sensors such as LiDAR 848 may be communicated from those sensors to the on-board computing device 820. The object detection information and/or captured images may be processed by the on-board computing device 820 to detect objects in proximity to the vehicle. Any known or to be known technique for making an object detection based on sensor data and/or captured images may be used in the embodiments disclosed in this document.

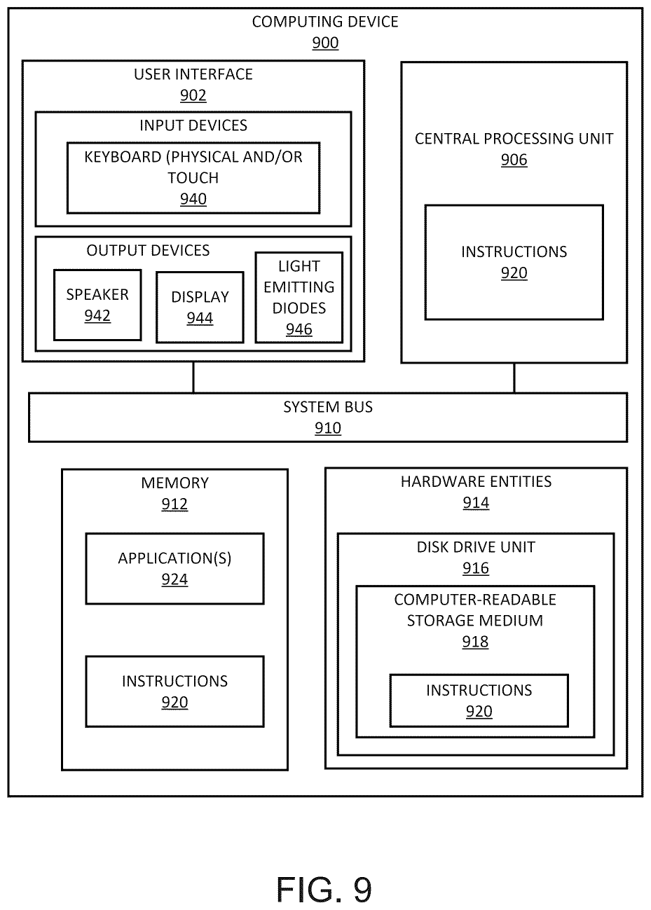

Referring now to FIG. 9, an illustration of an example architecture for a computing device 900 is provided. According to an exemplary embodiment, one or more functions of the present disclosure may be implemented by a computing device such as, e.g., computing device 900 or a computing device similar to computing device 900. Computing device 900 may be a quantum computer, a classical computer, and/or have one or more components configured to perform one or more quantum and/or classical computing functions. Tow vehicle controller 114, trailer controller 118, and/or computing device 820 may be an example of computing device 900 and/or may comprise one or more components of computing device 900.

The hardware architecture of FIG. 9 represents one example implementation of a representative computing device configured to implement at least a portion of the systems/devices (e.g., tow vehicle 100, e-trailer 102) and method(s)/control logic(s) (e.g., flowcharts 400, 500, and 700) described herein.

Some or all components of the computing device 900 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 9, the computing device 900 may comprise a user interface 902 (e.g., a graphical user interface), a Central Processing Unit (“CPU”) 906, a system bus 910, a memory 912 connected to and accessible by other portions of computing device 900 through system bus 910, and hardware entities 914 connected to system bus 910. The user interface may comprise input devices and output devices, which may be configured to facilitate user-software interactions for controlling operations of the computing device 900. The input devices may comprise, but are not limited to, a physical and/or touch keyboard 940. The input devices may be connected to the computing device 900 via a wired or wireless connection (e.g., a Bluetooth® connection). The output devices may comprise, but are not limited to, a speaker 942, a display 944, and/or light emitting diodes 946.

At least some of the hardware entities 914 may be configured to perform actions involving access to and use of memory 912, which may be a Random Access Memory (RAM), a disk driver and/or a Compact Disc Read Only Memory (CD-ROM), among other suitable memory types. Hardware entities 914 may comprise a disk drive unit 916 comprising a computer-readable storage medium 918 on which may be stored one or more sets of instructions 920 (e.g., programming instructions such as, but not limited to, software code) configured to implement one or more of the methodologies, procedures, or functions described herein. The instructions 920 may also reside, completely or at least partially, within the memory 912 and/or within the CPU 906 during execution thereof by the computing device 900.

The memory 912 and the CPU 906 may also constitute machine-readable media. The term “machine-readable media”, as used here, refers to a single medium or multiple media (e.g., a centralized or distributed database, and/or associated caches and servers) that store the one or more sets of instructions 920. The term “machine-readable media”, as used here, also refers to any medium that is capable of storing, encoding, or carrying a set of instructions 920 for execution by the computing device 900 and that cause the computing device 900 to perform any one or more of the methodologies of the present disclosure. According to various embodiments, one or more computer applications 924 may be stored on the memory 912.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method for estimating a driving range of a tow vehicle towing a self-propelled trailer, comprising:
selecting, using a graphical user interface of a computing device, a towing configuration,
wherein the towing configuration comprises a tow vehicle and a self-propelled trailer;
calculating an energy consumption rate for driving for the tow vehicle and the self-propelled trailer; and
for each of the tow vehicle and the self-propelled trailer:
calculating a total remaining energy available for driving; and
calculating an estimated driving range, according to the energy consumption rate for driving and the total remaining energy available for driving.

2. The method of claim 1, wherein the selecting the towing configuration comprises selecting a towing configuration from a plurality of pre-defined towing configurations.

3. The method of claim 1, wherein the calculating the energy consumption rate for driving comprises determining a towing force and a tongue force.

4. The method of claim 3, wherein the calculating the energy consumption rate for driving comprises determining a mass and resistance coefficients based on the selected towing configuration.

5. The method of claim 1, wherein the calculating the energy consumption rate for driving comprises configuring a travel route of the tow vehicle.

6. The method of claim 1, wherein, for each of the tow vehicle and the self-propelled trailer, the calculating the total remaining energy available for driving comprises detecting, using one or more sensors, one or more of: a battery state of charge; a battery state of health; and a battery state of temperature.

7. The method of claim 6, wherein, for each of the tow vehicle and the self-propelled trailer, the calculating the total remaining energy available for driving comprises estimating an energy needed for conditioning.

8. The method of claim 7, wherein, for each of the tow vehicle and the self-propelled trailer, the calculating the total remaining energy available for driving comprises subtracting battery stored energy by the energy needed for conditioning.

9. The method of claim 1, wherein the tow vehicle comprises an electric vehicle comprising a battery.

10. The method of claim 1, further comprising, when the tow vehicle is in motion, continuously updating the estimated drive range.

11. A system for estimating a driving range of a tow vehicle towing a self-propelled trailer, comprising:
the self-propelled trailer; and
the tow vehicle, comprising a computing device, wherein:
the computing device comprises a processor and a memory, and
the memory is configured to store instructions that, when executed by the processor, are configured to cause the processor to:
select, using a graphical user interface of the computing device, a towing configuration,
wherein the towing configuration comprises a tow vehicle and a self-propelled trailer;
calculate an energy consumption rate for driving for the tow vehicle and the self-propelled trailer; and
for each of the tow vehicle and the self-propelled trailer:
calculate a total remaining energy available for driving; and
calculate an estimated driving range, according to the energy consumption rate for driving and the total remaining energy available for driving.

12. The system of claim 11, wherein the selecting the towing configuration comprises selecting a towing configuration from a plurality of pre-defined towing configurations.

13. The system of claim 11, wherein the calculating the energy consumption rate for driving comprises determining a towing force and a tongue force.

14. The system of claim 13, wherein the calculating the energy consumption rate for driving comprises determining a mass and resistance coefficients based on the selected towing configuration.

15. The system of claim 11, wherein the calculating the energy consumption rate for driving comprises configuring a travel route of the tow vehicle.

16. The system of claim 11, wherein, for each of the tow vehicle and the self-propelled trailer, the calculating the total remaining energy available for driving comprises detecting, using one or more sensors, one or more of: a battery state of charge; a battery state of health; and a battery state of temperature.

17. The system of claim 16, wherein, for each of the tow vehicle and the self-propelled trailer, the calculating the total remaining energy available for driving comprises estimating an energy needed for conditioning.

18. The system of claim 17, wherein, for each of the tow vehicle and the self-propelled trailer, the calculating the total remaining energy available for driving comprises subtracting battery stored energy by the energy needed for conditioning.

19. The system of claim 11, wherein the tow vehicle comprises an electric vehicle comprising a battery.

20. The system of claim 11, wherein the instructions, when executed by the processor, are configured to cause the processor to continuously update the estimated drive range when the tow vehicle is in motion.
